(19) United States
(12) Patent Application Publication
(10) Pub. No.: US 2009/0195968 A1
(43) Pub. Date: Aug. 6, 2009

(54) SOLID ELECTROLYTIC CAPACITOR

(75) Inventor: Kazumi Naito, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., TOKYO (JP)

(21) Appl. No.: 12/306,856

(22) PCT Filed: Jun. 15, 2007
(86) PCT No.: PCT/JP2007/062133

§ 371 Date: Jan. 22, 2009

(30) Foreign Application Priority Data
Jun. 27, 2006 (JP) 2006-176457

(51) Int. Cl. H01G 9/15; H01G 9/022

(52) U.S. Cl. 361/525; 252/62.2

(57) ABSTRACT

A dielectric layer and a solid electrolyte layer are formed on the surface of a positive electrode member composed of a metallic material having a valve action or a conductive oxide. Then, a conductive carbon paste, and a conductive metal paste comprising a metal conductive powder and an acrylic resin having a weight average molecular weight of 60,000 or less are laminated, and thus a conductor layer is formed. By doing so, a solid electrolytic capacitor element is obtained. This solid electrolytic capacitor element is sealed with resin, and a large-capacity solid electrolytic capacitor is thereby obtained in which even when it is subjected to thermal stress caused by soldering, an equivalent series resistance (ESR) and a leakage current are not increased.

### TECHNICAL FIELD

The present invention relates to a solid electrolytic capacitor. More particularly, the invention relates to a solid electrolytic capacitor in which even when it is subjected to thermal stress caused by soldering, an equivalent series resistance (ESR) and a leakage current are not increased.

### BACKGROUND ART

A solid electrolytic capacitor is formed by sealing a solid electrolytic capacitor element with resin or the like. This solid electrolytic capacitor element is configured such that a positive electrode member, a dielectric layer, a solid electrolyte layer, a conductive carbon layer and a conductive metal layer are laminated in this order. The positive electrode member, for example, is made of a porous body obtained by molding and sintering powders of valve metal. The dielectric layer, for example, is made of a dielectric oxide film formed by anodizing the entire surface of the porous body. A positive electrode lead is electrically connected to the positive electrode member, and the positive electrode lead is exposed to the outside of the package of the solid electrolytic capacitor and serves as a positive electrode terminal. Meanwhile, a negative electrode layer is composed of the conductive carbon layer and the conductive metal layer laminated on the solid electrolyte layer. A negative electrode lead is electrically connected to the negative electrode layer, and the negative electrode lead is exposed to the outside of the package of the solid electrolytic capacitor and serves as a negative electrode terminal. The solid electrolytic capacitor element is sealed with a package material such as an epoxy resin.

Solid electrolytic capacitors are usually used by being soldered to a printed circuit board. The dipping method and the reflow method are known as soldering methods. The dipping method is to solder a printed circuit board on which electronic components are mounted by dipping it into molten solder maintained at a temperature of around 260° C. for 5 to 10 seconds. The reflow method is to solder a printed circuit board on which electronic components are mounted by placing it in an atmosphere maintained at a temperature of about 230° C. and spraying with molten solder. In both methods, solid electrolytic capacitors are subjected to thermal stress.

When solid electrolytic capacitors are subjected to extreme thermal stress, an equivalent series resistance (ESR) and a leakage current may be increased. It is thought that the ESR is increased because the conductive metal layer softens and thus partly becomes thin, and this causes a conductive path to become narrow. It is thought that the leakage current is increased because mechanical stress resulting from thermal expansion of the package is placed on the dielectric layer of the capacitor element, and this causes damage such as cracks in the dielectric layer.

A silver layer that serves as a conductive metal layer and that is formed of silver paste obtained by mixing silver particulates and cellulosic resin is disclosed in Patent Document 1. In Patent Document 2, a silver layer having a double-layer structure is disclosed in which a second silver layer formed by using, as a binder, thermosetting resin such as phenol resin is formed on a first silver layer formed by using, as a binder, thermoplastic resin such as acrylic resin.

Patent Document 1: Japanese Patent Laid-Open No. H8-162371

Patent Document 2: Japanese Patent Laid-Open No. 2005-294385

### DISCLOSURE OF THE INVENTION

### Problems to be Solved by the Invention

The inventor of the present invention tried to fabricate large-capacity solid electrolytic capacitors using the silver pastes disclosed in Patent Document 1, Patent Document 2 and the like. However, the inventor found that when the solid electrolytic capacitors are subjected to a soldering process in which a lead-free solder having a high melting point is used, increases in ESR and leakage current are not sufficiently restrained.

An object of the present invention is to provide a large-capacity solid electrolytic capacitor in which even when it is subjected to thermal stress caused by soldering, an equivalent series resistance (ESR) and a leakage current are hardly increased.

### Means for Solving the Problems

The inventor fully examined a conductive metal powder, a binder resin and other components for use in a conductive metal layer. As a result, the inventor found that when a conductive metal paste comprising a conductive metal powder such as a silver powder and an acrylic resin, such as poly-methyl methacrylate, having a weight average molecular weight of 60,000 or less is used in the conductive metal layer of a solid electrolytic capacitor element, a large-capacity solid electrolytic capacitor in which an equivalent series resistance (ESR) and a leakage current are hardly increased even if it is subjected to thermal stress of around 260° C. caused by soldering can be obtained. The present invention is completed based on these findings and further examination.

The present invention includes the followings.

(1) A solid electrolytic capacitor formed by sealing a solid electrolytic capacitor element in which a dielectric layer, a solid electrolyte layer, a conductive carbon layer and a conductive metal layer comprising a conductive metal powder and an acrylic resin having a weight average molecular weight of 60,000 or less are laminated one after another on a surface of a positive electrode member.
(2) The solid electrolytic capacitor according to (1), in which the conductive metal powder is at least one of powder selected from the group consisting of a silver powder, a copper powder, an aluminum powder, a nickel powder, a copper-nickel alloy powder, a silver alloy powder, a silver composite powder and a silver coated powder.
(3) The solid electrolytic capacitor according to (1) or (2), in which the acrylic resin is a polymer comprising methyl methacrylate as a main repeating unit.
(4) The solid electrolytic capacitor according to any one of (1) to (3), in which the conductive metal layer comprises 3 to 10% by mass of the acrylic resin having a weight average molecular weight of 60,000 or less and 90 to 97% by mass of the conductive metal powder.
(5) The solid electrolytic capacitor according to any one of (1) to (4), in which the positive electrode member is made of a metallic material having a valve action.
(6) The solid electrolytic capacitor according to any one of (1) to (5), in which the metallic material having a valve action is at least one of material selected from the group consisting of aluminum, tantalum, niobium, titanium, zirconium and alloys thereof.
(7) The solid electrolytic capacitor according to any one of (1) to (6), in which the positive electrode member is composed of a sintered tantalum powder compact in which a product (CV) of an electrostatic capacitance and a formation voltage is 100,000 μF·V/g or more.
(8) The solid electrolytic capacitor according to any one of (1) to (6), in which the positive electrode member is composed of a sintered niobium powder compact in which a product (CV) of an electrostatic capacitance and a formation voltage is 200,000 μF·V/g or more.
(9) The solid electrolytic capacitor according to any one of (1) to (8), in which the solid electrolyte layer is composed of a solid polymeric electrolyte comprising at least one of repeating units derived from pyrrole, thiophene, aniline, furane or derivatives thereof.
(10) The solid electrolytic capacitor according to any one of (1) to (8), in which a solid electrolyte comprises a polymer of 3,4-ethylenedioxythiophene.
(11) The solid electrolytic capacitor according to (9) or (10), in which the solid electrolyte further comprises an aryl sulfonate dopant.
(12) The solid electrolytic capacitor according to any one of (1) to (11), in which a product of a rated voltage and a capacity thereof is 2500 V·μF or more for D size (7.3 mm×4.3 mm×2.8 mm), 1700 V·μF or more for V size (7.3 mm×4.3 mm×1.8 mm), 1370 V·μF or more for C2 size (6.0 mm×3.2 mm×1.8 mm), 1700 V·μF or more for C size (6.0 mm×3.2 mm×2.5 mm), 800 V·μF or more for B size (3.4 mm×2.8 mm×1.8 mm) or 550 V·μF or more for A size (3.2 mm×1.6 mm×1.2 mm).
(13) A conductive metal paste for use in a solid electrolytic capacitor element, the paste comprising a conductive metal powder and an acrylic resin having a weight average molecular weight of 60,000 or less.
(14) The conductive metal paste for use in a solid electrolytic capacitor element according to (13), in which the solid electrolytic capacitor element comprises a positive electrode member composed of a sintered tantalum powder compact having a product (CV) of an electrostatic capacitance and a formation voltage of 100,000 μF·V/g or more, or a sintered niobium powder compact having a product (CV) of an electrostatic capacitance and a formation voltage of 200,000 μF·V/g or more.
(15) The conductive metal paste for use in a solid electrolytic capacitor element according to (13) or (14), in which the conductive metal powder is a silver powder, and the acrylic resin is a polymer comprising methyl methacrylate as a main repeating unit.
(16) The conductive metal paste according to any one of (13) to (15), in which the conductive metal paste comprises 3 to 10% by mass of the acrylic resin having a weight average molecular weight of 60,000 or less and 90 to 97% by mass of the conductive metal powder (a total of the acrylic resin having a weight average molecular weight of 60,000 or less and the conductive metal powder is 100% by mass).

### Advantages of the Invention

In a solid electrolytic capacitor of the present invention, even when it is subjected to thermal stress caused by soldering, an equivalent series resistance (ESR) is kept in an initial state in which it is low and a leakage current is low.

### BEST MODE FOR CARRYING OUT THE INVENTION

The present invention will be described below in detail.

A solid electrolytic capacitor of the present invention is formed by sealing a solid electrolytic capacitor element. The solid electrolytic capacitor element is configured such that a dielectric layer, a solid electrolyte layer, a conductive carbon layer and a conductive metal layer comprising conductive metal powder and an acrylic resin having a weight average molecular weight of 60,000 or less are laminated one after another on the surface of a positive electrode member.

### (Positive Electrode Member)

The positive electrode member of the solid electrolytic capacitor element is usually made of a metallic material having a valve action. Metallic materials having a valve action include aluminum, tantalum, niobium, titanium, zirconium and their alloys. The positive electrode member is appropriately selected from those in the form of, such as foil, bar and porous body. The thickness of the foil of the metallic material having a valve action varies according to the applications of the capacitor, and usually ranges from about 40 μm to about 150 μm. The size and shape of the foil of the metallic material having a valve action vary according to the applications of the capacitor; the foil for each flat-plate element preferably has a width of about 1 mm to about 50 mm, a length of about 1 mm to about 50 mm and a rectangular shape. More preferably it has a width of about 2 mm to about 20 mm, a length of about 2 mm to about 20 mm and a rectangular shape. Most preferably it has a width of about 2 mm to about 5 mm, a length of about 2 mm to about 6 mm and a rectangular shape. The porous body is preferably obtained by sintering powders of the metallic material having a valve action. The positive electrode member used in the present invention is preferably a sintered tantalum powder compact having a product (CV) of an electrostatic capacitance and a formation voltage of 100,000 μF·V/g or more, or a sintered niobium powder compact having a product (CV) of an electrostatic capacitance and a formation voltage of 200,000 μF·V/g or more.

The product (CV) of an electrostatic capacitance and a formation voltage is determined as follows. A sintered compact obtained by performing sintering in vacuum at a temperature of 1300° C. for 20 minutes is immersed in a 1% phosphoric acid aqueous solution maintained at a temperature of 65° C. and is subjected to a chemical conversion treatment by application of a formation voltage of 20 V for 300 minutes. Then, the sintered compact is immersed in a 40% sulfuric acid aqueous solution, and its capacitance is measured, when a 120 Hz voltage is applied to it at room temperature, with an LCR meter made by Agilent Technologies Inc. The product (CV) is determined by dividing the product of the formation voltage and the measured capacitance by the weight of the sintered compact.

### (Dielectric Layer)

In the solid electrolytic capacitor element, the dielectric layer is layered in the surface of the positive electrode member. The dielectric layer can be formed by oxidizing the surface of the positive electrode member by oxygen in the air. But preferably, the surface of the positive electrode member is oxidized by a chemical conversion treatment that will be described later.

Before the surface of the positive electrode member is oxidized, it is preferably roughened by a known method such as etching. In addition, the positive electrode member is preferably cut to suit the size of the solid electrolytic capacitor element.

The chemical conversion treatment for the positive electrode member can be performed by various methods. Conditions for the chemical conversion treatment, such as a chemical conversion solution and a formation voltage can be determined as appropriate according to, such as, a capacitance and a withstand voltage required for a solid electrolytic capacitor element to be manufactured.

The chemical conversion solution is, for example, a solution containing at least one of acids such as oxalic acid, adipic acid, boric acid and phosphoric acid and their salts. The concentration of the chemical conversion solution is usually 0.05% by mass to 20% by mass and is preferably 0.1% by mass to 15% by mass. The temperature of the chemical conversion solution is usually 0° C. to 90° C. and is preferably 20° C. to 70° C. The density of a current used for the chemical conversion treatment is usually 0.1 mA/cm² to 200 MA/cm² and is preferably 1 mA/cm² to 100 mA/cm². The time period during which the chemical conversion treatment is performed is usually 1000 minutes or less and is preferably 500 minutes or less.

Before or after the chemical conversion treatment, as required, a phosphoric acid immersion treatment for improvement of water resistance, a heat treatment for improvement of durability of the film, a boiled water immersion treatment or other treatments may be performed, for example. Moreover, in order to prevent the chemical conversion solution from slowly leaking to a positive electrode portion and ensure insulation from a solid electrolyte (a negative electrode portion) formed in the succeeding step, a masking layer may be formed at the boundary of the positive electrode and the negative electrode, or alternatively a positive electrode lead wire (if present) may be provided with an insulating washer.

The masking layer is made of a commonly-used heat resistant resin, or preferably a heat resistant resin that can dissolve or swell in a solvent or its precursor, a composition composed of inorganic fine powders and cellulosic resin (see Japanese Patent Laid-Open No. H11-080596) and the like. Polyphenyl sulfone (PPS), polyether sulfone (PES), cyanate ester resin, fluorine resin (tetrafluoroethylene, tetrafluoroethylene-perfluoroalkyl vinyl ether copolymer, etc.), low molecular weight polyimide and their derivatives are mentioned as materials constituting the masking layer. Among them, low molecular weight polyimide, polyether sulfone, fluorine resin and their precursors are preferable.

### (Solid Electrolyte Layer)

In the solid electrolytic capacitor element, the solid electrolyte layer is laminated on the surface of the dielectric layer. The solid electrolyte layer is made of a material that is conventionally known as a material for a solid electrolyte. As the preferable material for a solid electrolyte, a conductive polymer (a solid polymeric electrolyte) comprising at least one of repeating units derived from pyrrole, thiophene, aniline, furane or their derivatives is mentioned. Among them, a conductive polymer of 3,4-ethylenedioxythiophene is especially preferable. The method of forming the solid electrolyte layer on the dielectric layer is not particularly limited, for example, mentioned is a method (disclosed in Japanese Patent Laid-Open No. H2-15611 (U.S. Pat. No. 4,910,645) or Japanese Patent Laid-Open No. H10-32145 (European Patent Publication No. 820076)), in which 3,4-ethylenedioxythiophene monomer and an oxidizing agent or a solution obtained by dissolving them in a solvent as required is applied onto a dielectric layer, which is impregnated as required, and is polymerized.

In the conductive polymer, an aryl sulfonate dopant is preferably used together. Acids such as benzene sulfonic acid, toluene sulfonic acid, naphthalene sulfonic acid, anthracene sulfonic acid and anthraquinone sulfonic acid and their salts are mentioned as the aryl sulfonate dopant.

The electrical conductivity of the solid electrolyte layer is preferably 0.1 to 200 S/cm, more preferably 1 to 150 S/cm and further preferably 10 to 100 S/cm.

### (Conductive Carbon Layer)

In the solid electrolytic capacitor element, the conductive carbon layer is formed on the solid electrolyte layer.

For example, a paste comprising conductive carbon and binder can be applied onto the solid electrolyte layer, impregnated, dried and thermally treated to form the conductive carbon layer. The conductive carbon includes a material containing usually 80% by mass or more of graphite powders, and preferably 95% by mass or more of graphite powders. As the graphite powders, scale-like or leaf-like natural graphite, carbon black such as acetylene black or KETJEN BLACK or the like are mentioned.

A preferred conductive carbon has a fixed carbon content of 97% by mass or more, an average particle diameter of 1 to 13 μm, an aspect ratio of 10 or less, and the amount of particles being 32 μm or more in a particle diameter of 12% by mass or less.

Binder (binding agent or bonding agent) is a component for tightly binding and fixing a large number of solid particles or the like to be reinforced; a resin component is mainly used. Phenolic resin, epoxy resin, unsaturated alkyd resin, polystyrene, acrylic resin, cellulosic resin, rubber and the like are specific examples of the binder. Rubber includes isoprene rubber, butadiene rubber, styrene/butadiene rubber, nitrile rubber, butyl rubber, ethylene/propylene copolymer (EPM, EPDM and the like), acrylic rubber, polysulfide rubber, fluorine polymer, silicone rubber, any other thermoplastic elastomer or the like. Among them, EPM, EPDM or fluorine polymer is preferable.

A solvent for use in the paste comprising the conductive carbon and the binder is not particularly limited; for example, N-methylpyrrolidone, N,N-dimethylacetamide, dimethylformamide, butyl acetate, water or the like is mentioned as the solvent. With respect to the compounding ratio between the conductive carbon and the binder contained in the conductive carbon paste, the conductive carbon per total dissolved solid mass is usually 30 to 99% by mass and is preferably 50 to 97% by mass, and the binder per total dissolved solid mass is usually 1 to 70% by mass and is preferably 3 to 50% by mass

### (Conductive Metal Layer)

The conductive metal layer composing the solid electrolytic capacitor of the present invention comprises a conductive metal powder and an acrylic resin. The conductive metal layer is formed on the conductive carbon layer described above.

As the conductive metal powder, a silver powder, a copper powder, an aluminum powder, a nickel powder, a copper-nickel alloy powder, a silver alloy powder, a silver composite powder, a silver coated powder or the like is mentioned. Among them, a silver powder, an alloy containing silver as the main ingredient (a silver-copper alloy, a silver-nickel alloy, a silver-palladium alloy or the like), composite powder containing silver as the main ingredient (silver and copper composite powder, silver, nickel and/or palladium composite powder or the like) or silver coated powder (copper and nickel powder with silver coated on the powder surface) is preferable. In particular, the silver powder is especially preferable.

The acrylic resin comprised in the conductive metal layer has a weight average molecular weight of 60,000 or less, and preferably 30,000 or less. The lower limit weight average molecular weight of the acrylic resin is not particularly limited as long as the acrylic resin can bond the conductive metal powders; it is preferably 4,000, and more preferably 5,000. The acrylic resin is a resin composed of polymers having main repeating units formed of methacrylic acid ester monomers or acrylic acid ester monomers. Methyl acrylate, ethyl acrylate, methyl methacrylate, ethyl methacrylate and the like are mentioned as the methacrylic acid ester monomers and the acrylic acid ester monomers. Acrylonitrile, methacrylonitrile, acrylamide, methacrylamide, styrene or the like may be copolymerized. A preferred acrylic resin for the present invention is a polymer comprising a main repeating unit formed of methyl methacrylate, and a particularly preferred acrylic resin is polymethyl methacrylate. The weight average molecular weight is determined by converting a value obtained by analysis through gel permeation chromatography (GPC) into the molecular weight of a standard polymer.

Resin other than the acrylic resin may be comprised in the conductive metal layer as long as the effects of the present invention are not impaired. Alkyd resin, epoxy resin, phenolic resin, imide resin, fluorine resin, ester resin, imide-amide resin, amide resin, styrene resin, urethane resin and the like are mentioned as the resin other than the acrylic resin.

Preferably, in the conductive metal layer, the acrylic resin is usually 3 to 60% by mass, preferably 3 to 10% by mass, and more preferably 5 to 10% by mass, and the conductive metal powder is usually 40 to 97% by mass, preferably 90 to 97% by mass and more preferably 90 to 95% by mass (provided that the total of the acrylic resin and the conductive metal powder is 100% by mass). When the proportion of the acrylic resin is too low, the adherence between the conductive metal layer and the conductive carbon layer is degraded, and thus an initial ESR tends to be low. In contrast, when the proportion of the acrylic resin is too high, ESR after the solid electrolytic capacitor is mounted tends to be high due to thermal stress caused in, such as a reflow furnace.

The conductive metal layer can be formed by applying paste (conductive metal paste) comprising the conductive metal powder and the acrylic resin onto the conductive carbon layer, impregnating, drying and thermally treating the paste. A solvent for use in preparing the conductive metal paste is not particularly limited as long as it can dissolve the acrylic resin and can be removed by being volatilized until the final stage of the manufacturing process of the solid electrolytic capacitor.

A resin hardener, a dispersing agent, a coupling agent (such as a titanium coupling agent or a silane coupling agent), powders of conductive polymeric metal oxide and the like may be compounded into the conductive metal paste. The conductive metal paste can be solidified by being heated with the hardener or the coupling agent to form into a rigid conductive metal layer.

The conductive metal layer is usually 1 to 100 μm thick and preferably 5 to 30 μm thick. Even the conductive metal layer used in the present invention has such a thin layer, the conductive metal powders are evenly deposited in a satisfactory manner, and thus its satisfactory conductivity can be maintained and its ESR is kept low. The entire layer obtained by laminating the conductive carbon layer and the conductive metal layer is also called a conductor layer.

Solid electrolytic capacitors of the present invention preferably have their sizes (the sizes of cases) and the products of their rated voltages and capacities as follows: 2500 V·μF or more for D size (7.3 mm long×4.3 mm wide×2.8 mm high); 1700 V·μF or more for V size (7.3 mm long×4.3 mm wide×1.8 mm high); 1370 V·μF or more for C2 size (6.0 mm long×3.2 mm wide×1.8 mm high); 1700 V·μF or more for C size (6.0 mm long×3.2 mm wide×2.5 mm high); 800 V·μF or more for B size (3.4 mm long×2.8 mm wide×1.8 mm high); and 550 V·μF or more for A size (3.2 mm long×1.6 mm wide×1.2 mm high). Theses sizes are set according to the specifications of EIAJ (Electronic Industries Association of Japan). The products of the rated voltages×capacities are determined at room temperature at 120 Hz with an LCR meter made by Agilent Technologies Inc.

In a small-size solid electrolytic capacitor element having a high product of its rated voltage×capacity, a sintered compact formed of more minute powders is used as a positive electrode member. The sintered compact formed of more minute powders has fine pores having small pore diameters, and thus solid electrolyte is difficult to penetrate into the deep portions of the fine pores. Consequently, the adherence between a solid electrolyte layer and a dielectric layer is likely to be degraded. When heat is applied to the solid electrolytic capacitor, a stress is more likely to be applied between the solid electrolyte layer and the dielectric layer in a direction in which they are separated due to different thermal expansion coefficients of the package resin and the positive electrode member in the solid electrolytic capacitor. This stress is significantly produced on a solid electrolytic capacitor in which a plurality of solid electrolytic capacitor elements are arranged in parallel and sealed with resin.

A detailed mechanism in which the conductive metal paste of the present invention restrains increases in ESR by thermal stress has not been understood, but this is probably because the conductive metal paste of the present invention alleviates stress caused by the difference between thermal expansion coefficients of the package resin and the positive electrode member, and thus reduces stress applied between the solid electrolyte layer and the dielectric layer. Consequently, it is assumed that the conductive metal paste of the present invention produces significant effects on the above-described small-size large-capacity solid electrolytic capacitor and solid electrolytic capacitor in which a plurality of solid electrolytic capacitor elements are arranged in parallel.

The solid electrolytic capacitor of the present invention is formed by sealing the solid electrolytic capacitor element. A single solid electrolytic capacitor element may be sealed, and a plurality of solid electrolytic capacitor elements arranged in the same direction without any gap between them may be sealed. The sealing method is not particularly limited. For example, a resin molded package, a resin case package, a metallic case package, a package formed by resin dipping, a laminated film package or the like is used. Among them, a resin molded package is preferable because its size and cost is easily reduced.

A positive electrode lead is electrically connected to the positive electrode member of the solid electrolytic capacitor element to be sealed, and the positive electrode lead is exposed to the outside of the package of the solid electrolytic capacitor and serves as a positive electrode terminal. In contrast, a negative electrode layer is composed of the conductive carbon layer and the conductive metal layer laminated on the solid electrolyte layer, and a negative electrode lead is electrically connected to the negative electrode layer, and the negative electrode lead is exposed to the outside of the package of the solid electrolytic capacitor and serves as a negative electrode terminal.

A more specific description will be given of a case where the positive electrode lead and the negative electrode lead are connected to the solid electrolytic capacitor element and the solid electrolytic capacitor element is packaged in a resin mold.

Part of the conductive metal layer of the solid electrolytic capacitor element is fitted to one end of a lead frame having a pair of ends disposed opposite each other, and part of the positive electrode member (the positive electrode lead wire when the positive electrode member has the positive electrode lead wire; in this case, the end of the positive electrode lead wire may be cut so that the lengths are equal) is fitted to the other end of the lead frame. For example, the former is electrically and mechanically joined by solidification of the conductive metal paste, and the latter is electrically and mechanically joined by welding. Then, the solid electrolytic capacitor element other than portions of the ends of the lead frame is sealed with resin, and the lead frame is cut and bent (may only be cut when the lead frame is located on the bottom surface of the resin seal and the lead frame other than its bottom surface or its bottom surface and side surfaces is sealed) at a predetermined portion of the lead frame other than the sealed portion. The lead frame is cut after being sealed and finally serves as an external terminal of the capacitor. The lead frame is foil-shaped or flat-plate-shaped, and is made of iron, copper, aluminum or an alloy having any one of these metals as the main ingredient. Part or the whole of the lead frame may be plated with solder, tin, titanium, gold, silver or the like. A foundation plating formed of nickel, copper or the like may be provided between the lead frame and the metallizing plating.

The lead frame may be plated with the various materials mentioned above before or after being cut and bent as described above. Alternatively, it is possible to perform plating before the solid electrolytic capacitor element is fitted and connected, and perform plating again at any time after the resin sealing is performed. The lead frame has a pair of ends disposed opposite each other, and a gap is formed between the ends. Thus, the positive electrode member of the solid electrolytic capacitor element is insulated from the conductive metal layer.

As the resin used for the resin molded package, a known resin that is used for sealing the solid electrolytic capacitor element, such as epoxy resin, phenolic resin or alkyd resin may be used. A low-stress resin is preferably used as the sealing resin because it makes it possible to reduce stress on the solid electrolytic capacitor element caused when it is sealed. A transfer machine serving as a manufacturing machine for performing resin sealing is preferably used. Silica particles may be contained in the resin used for the package.

In order to repair thermal and/or physical deterioration of the dielectric layer, aging may be performed on the solid electrolytic capacitor fabricated as described above. The aging method is performed by applying a predetermined voltage (usually no higher than a voltage twice as much as the rated voltage) to the solid electrolytic capacitor. Since optimum aging period and temperature depend on the type, capacity and rated voltage of the capacitor, they are previously determined by experiment; but the aging is usually performed for a period of a few minutes to a few days at a temperature of 300° C. or less in consideration of thermal deterioration of a voltage applying jig. The aging may be performed in an atmosphere of air or a gas such as argon, nitrogen or helium. The aging may be performed at a reduced pressure, a normal pressure or an increased pressure. If the aging is performed while water vapor is being supplied or after water vapor is supplied, the dielectric layer may be further stabilized. After water vapor is supplied and then excess water is removed by maintaining the solid electrolytic capacitor at a high temperature of 150 to 250° C. for a few minutes to a few hours, the aging may be performed.

With respect to a method for applying voltage, any current such as a direct current, an alternating current (having any waveform), an alternating current superimposed on a direct current, a pulse current or the like may be applied. Alternatively, it is possible to stop applying voltage during the aging and reapply it.

The solid electrolytic capacitor of the present invention can be preferably used for circuits, such as CPUs and power supply circuits, required to use a large-capacity capacitor. These circuits can be used for various digital devices such as personal computers, servers, cameras, game machines, DVD devices, AV devices and mobile telephones or electronic devices such as various power supplies.

The solid electrolytic capacitor of the invention has a satisfactory ESR. Thus, with this, it is possible to obtain electronic circuits and devices that have high-speed responsivity.

### EXAMPLES

Typical examples of the present invention will be shown below to explain the present invention more specifically. These are just examples for explaining the invention. The present invention is not limited to these examples.

### Examples 1 To 5 and Comparative Examples 1 To 5

Together with a 0.40 mm Φ tantalum lead wire (13.0 mm long), 24.1 mg of tantalum powder was molded, and this was sintered in a vacuum at a temperature of 1325° C. for 20 minutes to obtain a sintered compact having CV (product of a capacitance and a formation voltage) of 160,000 μF·V/g, density of 6.3 g/cm³, and size of 1.0 mm×1.2 mm×3.4 mm. The 3.0 mm long portion of the tantalum lead wire was buried in parallel with a longitudinal direction of the sintered compact 3.4 mm long, and the 10 mm long portion of the tantalum lead wire protrudes from the sintered compact and serves as a positive electrode portion.

The sintered compact other than a portion of the lead wire was immersed in a 1% anthraquinone sulfonic acid aqueous solution maintained at a temperature of 65° C., and chemical conversion treatment was performed for 400 minutes by applying a voltage of 9 volts between the sintered compact (positive electrode) and a tantalum plate electrode (negative electrode) to make a dielectric layer containing Ta₂O₅ in the surface of the sintered compact. On the dielectric layer, a semiconductor (solid electrolyte) layer composed of polypyrrole having naphthalene sulfonate ions as the main dopant was formed by electrolytic polymerization. Then, conductive carbon paste was applied onto the semiconductor layer and dried. Then, silver paste composed of silver powders (whose number average particle diameter is 3 pm) and polymethyl methacrylate following the recipe shown in table 1 was laminated and dried, and thus a conductor layer was formed to make the solid electrolytic capacitor elements.

Two of the solid electrolytic capacitor elements were placed to face in the same direction without any gap therebetween such that the tantalum lead wire protruding from the sintered compact and the silver paste layer (1.2 mm×3.4 mm side) of the conductor layer were fitted to a pair of ends of a lead frame serving as an external electrode. The tantalum lead wire was electrically and mechanically connected to the lead frame by spot welding; the conductor layer was electrically and mechanically connected to the lead frame with silver paste.

Thereafter, the solid electrolytic capacitor elements other than a portion of the lead frame were transfer molded with epoxy resin, and a predetermined portion of the lead frame outside the mold was cut. Then, the lead frame was bent along a package to form an external terminal to make a solid electrolytic capacitor chip having size of 6.0 mm×3.2 mm×1.8 mm (C2 size) . Then, it was placed at a temperature of 150° C. for 5 hours so that the sealing resin was cured, and it was placed in a temperature and humidity controlled room having a temperature of 60° C. and a relative humidity of 90% for 24 hours. Moreover, aging was performed at a temperature of 135° C. for 4 hours through application of a voltage of 3 volts, and the solid electrolytic capacitors were finally made.

TABLE 1

| | Examples | | | | | Comparative examples | | | | |
|---|---|---|---|---|---|---|---|---|---|---|
| Silver paste | 1 | 2 | 3 | 4 | 5 | 1 | 2 | 3 | 4 | 5 |
| Silver powder | 97 | 97 | 97 | 97 | 97 | 97 | 97 | 97 | 97 | 97 |
| (mass %) | | | | | | | | | | |
| Silver powder | 3 | 3 | 3 | 3 | 3 | 3 | 3 | 3 | 3 | 3 |
| average | | | | | | | | | | |
| Diameter (mm) | | | | | | | | | | |
| polymethyl | 3 | 3 | 3 | 3 | 3 | 3 | 3 | 3 | 3 | 3 |
| methacrylate | | | | | | | | | | |
| (mass %) | | | | | | | | | | |
| weight-average | 4.8 | 9.6 | 15 | 28 | 56 | 68 | 93 | 120 | 350 | 996 |
| molecular | | | | | | | | | | |
| weight (×10³) | | | | | | | | | | |
| Initial ESR (mΩ) | 5 | 5 | 6 | 6 | 6 | 6 | 6 | 7 | 7 | 7 |
| ESR after being | 5 | 5 | 6 | 6 | 8 | 10 | 12 | 15 | 16 | 16 |
| mounted (mΩ) | | | | | | | | | | |

### Examples 6 To 7 and Comparative Examples 6 to 7

Niobium powders (as a whole, containing 9,600 ppm of oxygen because their surfaces are naturally oxidized since they are minute particles) having an average particle diameter of 140 μm were obtained by granulating primary niobium powders (having an average particle diameter of 0.31 μm) obtained by crashing a niobium ingot through use of hydrogen brittleness. The niobium powders were then placed in an atmosphere of nitrogen maintained at a temperature of 450° C. and then were placed in an atmosphere of argon maintained at a temperature of 700° C., and thus partly nitrided niobium powders (CV: 285,000 μF·V/g) being 9,000 ppm in an amount nitrided were obtained. The partly nitrided niobium powders were molded together with a 0.38 mm Φ diameter niobium lead wire (13.5 mm long) and were sintered at a temperature of 1260° C., with result that a plurality of sintered compacts measuring 1.0 mm×1.5 mm×4.4 mm (weighing 22.1 mg; a 3.5 mm portion of the niobium lead wire was buried and a 10 mm portion of the niobium lead wire was protruded to the outside) were made.

The sintered compacts were immersed in an aqueous solution containing 5% of ammonium benzoate and 1% of toluene sulfonic acid, and were subjected to chemical conversion treatment at a temperature of 80° C. by application of a voltage of 20 Volts for 7 hours. Thus, a dielectric layer having diniobium pentoxide as the main ingredient was formed in the surface of the sintered compacts and a portion of the niobium lead wire. Then, on the dielectric layer, a semiconductor (solid electrolyte) layer composed of poly 3,4-dioxythiophene polymer having anthraquinone sulfonic acid ions as the main dopant was formed by electrolytic polymerization. Then, on the semiconductor layer, conductive carbon paste was laminated and dried, and then the silver paste composed of silver powders and polymethyl methacrylate following the recipe shown in table 2 was laminated thereon and dried, and thus a conductor layer was formed. By doing so, solid electrolytic capacitor elements were made.

Two of the solid electrolytic capacitor elements were placed to face in the same direction without any gap therebetween such that the niobium lead wire protruding from the sintered compact and the silver paste layer (1.5 mm×4.4 mm side) of the conductor layer were fitted to a pair of ends of a lead frame serving as an external electrode. The niobium lead wire was electrically and mechanically connected to the lead frame by spot welding; the conductor layer was electrically and mechanically connected to the lead frame with silver paste. Thereafter, the solid electrolytic capacitor elements other than a portion of the lead frame were transfer molded with epoxy resin, and a predetermined portion of the lead frame outside the mold was cut. Then, the lead frame was bent along a package to form an external terminal. By doing so, a solid electrolytic capacitor chip having size of 7.3 mm×4.3 mm×1.8 mm (V size) was made. Then, it was placed at a temperature of 150° C. for 5 hours so that the sealing resin was cured, and it was placed in a temperature and humidity controlled room having a temperature of 60° C. and a relative humidity of 90% RH for 24 hours. Moreover, aging was performed at a temperature of 135° C. for 4 hours through application of a voltage of 3 volts, and the solid electrolytic capacitors were finally made.

TABLE 2

| | |
|---|---|
| | Comparative |
| Examples | examples |

| Silver paste | 6 | 7 | 6 | 7 |
|---|---|---|---|---|
| Silver powder | 92 | 92 | 92 | 92 |
| (mass %) | | | | |
| Silver powder | 6 | 6 | 6 | 6 |
| average | | | | |
| Diameter (mm) | | | | |
| polymethyl | 8 | 8 | 8 | 8 |
| methacrylate | | | | |
| (mass %) | | | | |
| weight-average | 9.6 | 28 | 93 | 350 |
| molecular | | | | |
| weight (×10³) | | | | |
| Initial ESR (mΩ) | 5 | 5 | 6 | 7 |
| ESR after being | 5 | 5 | 12 | 15 |
| mounted (mΩ) | | | | |

Initial ESRs (at a room temperature and at 100 kHz) of the solid electrolytic capacitors obtained in Examples and Comparative Examples described above were measured with the LCR meter made by Agilent Technologies Inc. Then, cream solder (“M705-GRN360-K2-V” made by Senju Metal Industry Co., Ltd.) was applied onto a predetermined land on a glass epoxy board being 78 mm long, 50 mm wide and 1.6 mm thick, and 10 pieces of the solid electrolytic capacitors were adhered to the applied film. The board to which the solid electrolytic capacitors were adhered was made to pass through a reflow furnace having a temperature pattern of 230° C. or more for 30 seconds and a set peak temperature of 260° C. three times. After the solid electrolytic capacitors passed through the reflow furnace (were subjected to mounting), their ESRs (at a room temperature and at 100 kHz) were measured with the LCR meter made by Agilent Technologies Inc. The results are shown in Tables 1 and 2.

The results of Tables 1 and 2 show that even when the solid electrolytic capacitors (Examples) in which the conductive metal layer was formed using the silver paste comprising an acrylic resin having a weight average molecular weight of 60,000 or less are subjected to thermal stress in a reflow furnance, their ESRs are almost not decreased. In contrast, they also show that when the solid electrolytic capacitors (Comparative Examples) in which the conductive metal layer was formed using the silver paste comprising an acrylic resin having a weight average molecular weight of more than 60,000 are subjected to thermal stress caused when they pass through a reflow furnace whose peak temperature is 260° C., their ESRs are significantly increased.

1. A solid electrolytic capacitor formed by sealing a solid electrolytic capacitor element in which a dielectric layer, a solid electrolyte layer, a conductive carbon layer and a conductive metal layer comprising a conductive metal powder and an acrylic resin having a weight average molecular weight of 60,000 or less are laminated one after another on a surface of a positive electrode member.

2. The solid electrolytic capacitor according to claim 1, in which the conductive metal powder is at least one of powder selected from the group consisting of a silver powder, a copper powder, an aluminum powder, a nickel powder, a copper-nickel alloy powder, a silver alloy powder, a silver composite powder and a silver coated powder.

3. The solid electrolytic capacitor according to claim 1, in which the acrylic resin is a polymer comprising methyl methacrylate as a main repeating unit.

4. The solid electrolytic capacitor according to claim 1, in which the conductive metal layer comprises 3 to 10% by mass of the acrylic resin having a weight average molecular weight of 60,000 or less and 90 to 97% by mass of the conductive metal powder (a total of the acrylic resin having a weight average molecular weight of 60,000 or less and the conductive metal powder is 100% by mass).

5. The solid electrolytic capacitor according to claim 1, in which the positive electrode member is made of a metallic material having a valve action.

6. The solid electrolytic capacitor according to claim 5, in which the metallic material having a valve action is at least one of material selected from the group consisting of aluminum, tantalum, niobium, titanium, zirconium and alloys thereof.

7. The solid electrolytic capacitor according to claim 1, in which the positive electrode member is composed of a sintered tantalum powder compact in which a product (CV) of an electrostatic capacitance and a formation voltage is 100,000 μF·V/g or more.

8. The solid electrolytic capacitor according to claim 1, in which the positive electrode member is composed of a sintered niobium powder compact in which a product (CV) of an electrostatic capacitance and a formation voltage is 200,000 μF·V/g or more.

9. The solid electrolytic capacitor according to claim 1, in which the solid electrolyte layer is composed of a solid polymeric electrolyte comprising at least one of repeating units derived from pyrrole, thiophene, aniline, furane or derivatives thereof.

10. The solid electrolytic capacitor according to claim 1, in which the solid electrolyte layer is composed of a solid polymeric electrolyte comprising a polymer of 3,4-ethylenedioxythiophene.

11. The solid electrolytic capacitor according to claim 9, in which the solid polymeric electrolyte further comprises an aryl sulfonate dopant.

12. The solid electrolytic capacitor according to claim 1, in which a product of a rated voltage and a capacity thereof is 2500 V·μF or more for D size (7.3 mm×4.3 mm×2.8 mm), 1700 V·μF or more for V size (7.3 mm×4.3 mm×1.8 mm), 1370 V·μF or more for C2 size (6.0 mm×3.2 mm×1.8 mm), 1700 V·μF or more for C size (6.0 mm×3.2 mm×2.5 mm), 800 V·μF or more for B size (3.4 mm×2.8 mm×1.8 mm) or 550 V·μF or more for A size (3.2 mm×1.6 mm×1.2 mm).

13. A conductive metal paste for use in a solid electrolytic capacitor element, the conductive metal paste comprising a conductive metal powder and an acrylic resin having a weight average molecular weight of 60,000 or less.

14. The conductive metal paste for use in a solid electrolytic capacitor element according to claim 13, in which the solid electrolytic capacitor element comprises a positive electrode member composed of a sintered tantalum powder compact in which a product (CV) of an electrostatic capacitance and a formation voltage is 100,000 μF·V/g or more, or a sintered niobium powder compact in which a product (CV) of an electrostatic capacitance and a formation voltage is 200,000 μF·V/g or more.

15. The conductive metal paste for use in a solid electrolytic capacitor element according to claim 13, in which the conductive metal powder is a silver powder, and the acrylic resin is a polymer comprising methyl methacrylate as a main repeating unit.

16. The conductive metal paste according to claim 13, in which the conductive metal paste comprises 3 to 10% by mass of the acrylic resin having a weight average molecular weight of 60,000 or less and 90 to 97% by mass of the conductive metal powder (a total of the acrylic resin having a weight average molecular weight of 60,000 or less and the conductive metal powder is 100% by mass).

17. The solid electrolytic capacitor according to claim 10, in which the solid electrolyte further comprises an aryl sulfonate dopant.
